(19) United States
(12) Patent Application Publication
(10) Pub. No.: US 2026/0115693 A1
(43) Pub. Date: Apr. 30, 2026

(54) METHOD FOR INCREASING LOADING CAPACITY OF HONEYCOMB CATALYST SUPPORT AND PREPARATION OF DENITRIFICATION CATALYST BASED ON CATALYST SUPPORT

(71) Applicants: FuZhou University, Fujian (CN); Qingyuan Innovation Laboratory, Fujian (CN)

(72) Inventors: Yuanyuan Yue, Fujian (CN); Peng Jiang, Fujian (CN); Xueli Ge, Fujian (CN); Huangcong Deng, Fujian (CN); Peiyou Ma, Fujian (CN); Xiaojun Bao, Fujian (CN); Tiesen Li, Fujian (CN); Qingyan Cui, Fujian (CN); Jie Shi, Fujian (CN)

(73) Assignees: FuZhou University, Fujian (CN); Qingyuan Innovation Laboratory, Fujian (CN)

(21) Appl. No.: 19/373,611

(22) Filed: Oct. 29, 2025

(30) Foreign Application Priority Data
Oct. 30, 2024 (CN) 202411531011.2

(51) Int. Cl. B01J 21/16; B01D 53/86; B01J 29/46; B01J 35/57; B01J 37/00; B01J 37/02; B01J 37/04; B01J 37/06; B01J 37/08

(52) U.S. Cl. CPC B01J 21/16; B01D 53/8628; B01J 29/46; B01J 35/57; B01J 37/0018; B01J 37/0217; B01J 37/0228; B01J 37/04; B01J 37/06; B01J 37/08; B01D 2255/20738; B01D 2255/20761; B01D 2255/504; B01D 2255/9155; B01D 2257/404; B01D 2258/0283

(57) ABSTRACT

Provided are a method for increasing the loading capacity of a honeycomb catalyst support and the preparation of a denitrification catalyst based on the catalyst support. First, a natural silica-aluminum mineral is used to prepare a honeycomb catalyst support, a water-soluble polymer fiber bundle is used as a structuring agent, and two processes of alkali etching and structuring water dissolution are performed for pretreatment to obtain a clay-based honeycomb catalyst support; then, the catalyst support is completely immersed in a molecular sieve-based coating slurry twice for immersion and coating, and then calcined to obtain a high-load molecular sieve-based coated honeycomb monolithic denitrification catalyst. According to the provided, by performing structural adjustment on a honeycomb catalyst support, inner wall channels are effectively widened.

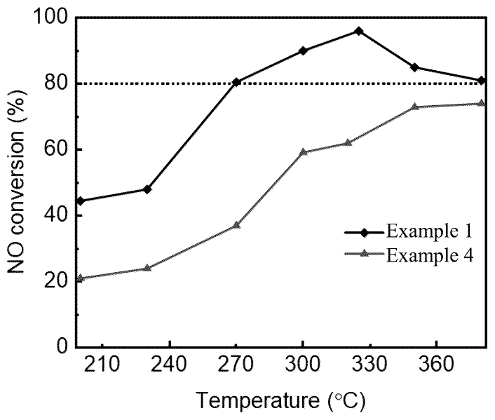

### CROSS-REFERENCE TO RELATED APPLICATION

This application claims the priority benefit of China application serial no. 202411531011.2, filed on Oct. 30, 2024. The entirety of the above-mentioned patent application is hereby incorporated by reference herein and made a part of this specification.

### TECHNICAL FIELD

The present invention belongs to the technical field of nitrogen oxide removal, and particularly relates to a method for increasing the loading capacity of a honeycomb catalyst support and the preparation of a denitrification catalyst based on the catalyst support.

### RELATED ART

Nitrogen oxides (NOₓ) are one of the main air pollutants and are extremely harmful to human beings, the environment and even social economy. Among the many denitrification technologies, NH₃-SCR (selective catalytic reduction with ammonia serving as a reducing agent) is the most mature and widely used.

In practical applications, honeycomb monolithic catalysts are mostly used. Compared with coated molecular sieve-based honeycomb monolithic catalysts, the honeycomb monolithic catalysts have obvious advantages: first, the consumption of molecular sieve-based catalysts is small, which saves a lot of production costs; second, the honeycomb monolithic catalysts can effectively replace traditional V-based catalysts, thereby reducing biotoxicity; third, the exposure rate of active sites is high and the accessibility of activity is high. However, due to the inert nature, molecular sieve-based catalysts are difficult to adhere, causing a significant challenge in improving the effective loading of the molecular sieve-based catalysts.

As disclosed in Chinese patent No. CN108889295B, by adopting an electromagnetic oscillation dispersion method, a coating technology tailored for high-viscosity catalytic slurries was developed. This technology effectively improves the dispersion state of SCR coating slurries, increases the load, and reduces the shedding rate as well as the pore-plugging rate. However, it is still difficult to apply the oscillation method in industrial application and the large-scale application of the method is a challenge. As disclosed in Chinese patent No. CN107597178B, starting from the coating slurry, α-Al₂O₃ is used as a binder to achieve the effective loading of molecular sieve catalysts. The load ranges from 1% to 10%, with a shedding rate of less than 20%. The catalytic performance is improved to a certain extent. As disclosed in Chinese patent application No. CN106268929A, the combination of Al sol and Si sol improves the stability of the slurry, reduces pore plugging and slurry hanging phenomena, and promotes the coating application of molecular sieve-based catalysts. In such techniques, although the coating slurry has been improved to a certain extent, the total load of the coating slurry on the support has reached saturation, making it difficult to continue to improve. Therefore, the catalyst support needs to be modified to a certain extent.

As disclosed in Chinese patent No. CN115417694B, a support was immersed and boiled in nitric acid solution, and then washed with water to obtain a honeycomb monolithic adsorbent. As disclosed in Chinese patent application No. CN107349968A, a honeycomb support was immersed in an organic solvent to obtain an SCR molecular sieve-based honeycomb catalyst. As disclosed in Chinese patent No. CN116023126B, pore-forming technology was used to improve the porosity of the honeycombs and create micropores so that the coating slurry could enter internal channels. The above technology illustrates the possibility of modifying the honeycomb support. Pretreating the honeycomb catalyst support can improve the surface roughness and porosity, and increase the slurry load to a certain extent. However, such technologies only perform microscopic treatment on the surface of supports and cannot achieve effective loading in the face of complex slurry conditions, easily causing pore plugging and slurry hanging.

### SUMMARY OF INVENTION

An object of the present invention is to provide a method for increasing the loading capacity of a honeycomb catalyst support and the preparation of a denitrification catalyst based on the catalyst support. Specifically, the present invention provides a method for increasing the loading capacity of a clay-based honeycomb catalyst support and a method for preparing a high-load molecular sieve-based coated honeycomb monolithic denitrification catalyst, in order to solve the problem that the inner walls of honeycomb catalyst supports are not connected. By performing structural adjustment on a honeycomb catalyst support, inner wall channels are effectively widened. Therefore, during subsequent preparation of the denitrification catalyst, the time and area of contact with the molecular sieve-based coating slurry are increased, the problem of difficulty in slurry adhesion is overcome, the phenomena of pore plugging and slurry hanging are ameliorated, the slurry load rate of the catalyst is increased, and the catalytic activity of the catalyst is improved.

In order to achieve the above object, the present invention adopts the following technical solutions:

The present invention first provides a method for increasing the loading capacity of a clay-based honeycomb catalyst support. The method includes the following steps:
(1) mixing a structuring agent and additives with a main material which is a natural silica-aluminum mineral to obtain a homogeneous powder; adding wet materials, and performing kneading, mud pugging, aging, pre-extrusion, extrusion molding, and pre-drying to obtain a clay-based honeycomb monolithic denitrification catalyst support;
(2) immersing the catalyst support in an alkali solution for etching treatment: the alkali solution has a pH of 8 to13 and a temperature of 20° C. to 90° C., and the immersion time ranges from 2 h to 4 h;
(3) then, performing structuring water dissolution treatment on the catalyst support: immersing the catalyst support in water with a temperature of 20° C. to 90° C. for 0.5 h to 2.0 h, and then rinsing with water with a temperature of 20° C. to 90° C. twice or three times (the temperature of the water in this step is set according to the dissolution temperature of the structuring agent); and
(4) finally, drying and calcining the catalyst support to obtain a structured clay-based honeycomb catalyst support.

The natural silica-aluminum mineral is one of feldspar, nepheline, leucite, beryl, muscovite, pyrophyllite, kaolinite, rectorite, jadeite, spodumene, boehmite, perlite, phlogopite, vermiculite, montmorillonite, talc, serpentine, illite, palygorite, sepiolite, diatomite, attapulgite, enstatite, diopside, amphibole and olivine or a combination thereof, and the content of impurities (substances other than alumina and silica) in the natural silica-aluminum mineral is less than 20 wt %, and the particle size of the natural silica-aluminum mineral is not less than 200 mesh.

The structuring agent is a water-soluble polymer fiber bundle, including one of polyvinyl alcohol fiber, seaweed fiber, and carboxymethyl cellulose fiber or a combination thereof. The structuring agent is required to be in a bundle shape. Specifically, The structuring agent is required to have a length of 0.2 mm to 3.0 mm and a diameter of 10 μm to 2000 μm. The length is adjusted on the basis of the honeycomb wall thickness to directly penetrate inner walls.

The additives include an organic binder, an extrusion aid, a pore-forming agent and a structure enhancer. Further, the organic binder is one of sodium carboxymethyl cellulose, sodium hydroxypropyl cellulose, polyethylene glycol, sodium polyacrylate, polyethylene oxide, and phenolic resin or a combination thereof; the extrusion aid is one of starch, sesbania powder, ethanolamine and sodium stearate or a combination thereof; the pore-forming agent is one of straw, rice hull, sawdust, wood chips and bamboo chips or a combination thereof, and the particle size of the pore-forming agent is not less than 200 mesh; the structure reinforcer is glass fiber with a length of 1.0 mm to 10.0 mm.

The wet materials include an inorganic binder, an organic acid, an inorganic acid, a humectant and water.

Further, the inorganic binder is one of silica sol, water glass, pseudo-boehmite and aluminum sol or a combination thereof; the organic acid is one of citric acid, tartaric acid, malic acid, oxalic acid and lactic acid or a combination thereof; and the inorganic acid is one of hydrochloric acid, nitric acid, sulfuric acid, phosphoric acid, carbonic acid and boric acid or a combination thereof. The concentration of an aqueous solution of the organic acid and the concentration of an aqueous solution of the inorganic acid are both in a range of 3 wt % to 20 wt %. The humectant is one of glycerol, tung oil and peanut oil or a combination thereof; and the water is one of deionized water, pure water and mineral water or a combination thereof.

Further, a mass ratio of the raw materials added is as follows: natural silica-aluminum mineral:organic binder:extrusion aid:structure enhancer:structuring agent:pore-forming agent:inorganic binder:organic acid:inorganic acid:humectant:water=45-100:1-5:1-8:1-5:10-50:1-15:3-8:1-5:1-5:3-10:10-30.

In step (1), the dry materials are mixed for 10 min to 60 min; the kneading refers to stirring after the addition of all the dry and wet materials and the mixing time is in a range of 10 min to 60 min; the mud pugging is performed twice or three times; the aging is performed for one day to ten days; the pre-extrusion involves trial extrusion and mold lubrication after mold changing, and the pre-extrusion is performed for 5 min to 30 min; the extrusion molding is double screw extrusion which cooperates with molds of different shapes, and wall thickness is adjusted within a range of 0.5 mm to 3.0 mm; the pre-drying is performed to pre-remove moisture by 5 wt % of the total mass of the extruded material.

In step (4), the drying is performed according to a temperature-humidity coordinated cross-control method, which means controlling the humidity and temperature curves to intersect and coordinating the drying process for dehydration, and the temperature ranges from 25° C. to 100° C. and the humidity ranges from 5% to 80%. In step (4), the calcination is performed in a muffle furnace under a closed condition according to a low-rate plateau heating method; the calcination is initiated from an temperature of greater than 80° C. with the temperature increased at a low rate of 0.5° C/min to 2° C./min, and calcination temperature ranges from 80° C. to 800° C.; during the calcination process, a plateau is set at a temperature in a range of 180° C. to 400° C. for calcination and binder removal, followed by further heating to a temperature ranging from 550° C. to 800° C. with a holding time of 6 h to 8 h for calcination.

The present invention further provides a method for preparing a high-load molecular sieve-based coated honeycomb monolithic denitrification catalyst. The method includes the following steps:
a) thoroughly mixing a molecular sieve, an organic binder, an inorganic binder, an acid and water in a mass ratio of 10-30:0-10:0-10:3-10:50-90 to obtain a molecular sieve-based coating slurry;
b) completely immersing the structured clay-based honeycomb catalyst support obtained in step 4) into the molecular sieve-based coating slurry for 4 h to 8 h, and then taking the catalyst support out, purging with compressed air (4 bar) until no liquid drops fall, and drying at a temperature of 80° C. to 100° C.; then, immersing the catalyst support again in the molecular sieve-based coating slurry for 4 h to 8 h, and then taking out, purging with compressed air until no liquid drops fall, and drying at a temperature of 80° C. to 100° C.; and
c) finally, calcining the material at a temperature of 500° C. to 600° C. to obtain a high-load molecular sieve-based coated honeycomb monolithic denitrification catalyst used in NH3-SCR reaction.

Load rate (L) is calculated according to the formula: L=(m₂−m₁)/m₁×100%, where m₁ is mass measured before immersion, m₂ is mass measured after the second immersion and drying.

In step a), the molecular sieve is one of ZSM-5 molecular sieve, ZSM-35 molecular sieve, SSZ-13 molecular sieve, SSZ-39 molecular sieve, SAPO-11 molecular sieve, SAPO-34 molecular sieve, SAPO-47 molecular sieve, Y-type molecular sieve, Beta molecular sieve, KFI type molecular sieve and mordenite or a combination thereof, and a molar ratio of silica to alumina in the molecular sieve is 2-300:1; a metal element contained in the molecular sieve is one of iron, copper, manganese, cerium, lanthanum, rhodium, ruthenium, palladium and osmium or a combination thereof, and the content of the metal element ranges from 0.1 wt % to 10.0 wt %.

In step a), the organic binder is one of sodium carboxymethyl cellulose, polyethylene glycol, polyethylene oxide, sodium polyacrylate and polyimide resin or a combination thereof; the inorganic binder is silica sol or aluminum sol; the acid is one of lactic acid, nitric acid, hydrochloric acid, sulfuric acid, phosphoric acid, carbonic acid and boric acid or a combination thereof; and the water is one of deionized water, pure water and mineral water or a combination thereof.

According to the present invention, based on the above technical solutions, a two-step pretreatment method including alkali etching and structuring water solubility is implemented during the preparation process of the catalyst support to create connecting channels between the inner walls, thus achieving high connectivity. Subsequently, the molecular sieve-based coating technology is adopted, so that internal pore plugging and slurry hanging of the high-connectivity support can be ameliorated, and a high-load molecular sieve-based coated honeycomb monolithic denitrification catalyst can be prepared.

Compared with the prior art, the present invention has the following beneficial effects:

According to the present invention, a natural silica-aluminum mineral and a structuring agent (water-soluble polymer fiber bundles) are used to prepare a catalyst support. The alkali etching properties of the natural silica-aluminum mineral are utilized to effectively control the surface roughness, retain the Al acid site in the natural silica-aluminum minerals, and increase adsorbability. The water solubility of the water-soluble polymer fiber bundles is utilized to effectively improve the connectivity of the inner walls, increase channels in contact with the slurry, and ameliorate the phenomena of pore plugging and slurry hanging.

In the technical solutions of the present invention, the honeycomb catalyst support is adjusted structurally, and the load of catalytic slurry is effectively increased by the two-step pretreatment technology, thereby facilitating the subsequent loading of the molecular sieve-based coating slurry, ameliorating pore plugging and shedding phenomena. Therefore, the invention has good industrial application prospects.

### BRIEF DESCRIPTION OF DRAWINGS

FIGURE is a comparative chart of the activities of catalysts prepared in Example 1 and Example 4.

### DESCRIPTION OF EMBODIMENTS

The invention will be further explained below in conjunction with specific examples, which are intended to illustrate the embodiments and features of the invention in detail and should not be construed as any limitation on the invention.

FeCu-ZSM-5, FeCu-SSZ-13, and FeCu-SAPO-34 molecular sieves in the examples are high-performance denitrification molecular sieves synthesized in situ by a one-pot method and belong to bimetallic molecular sieve-based catalysts. The introduction of Cu can not only regulate the acidity of the framework Fe³⁺ and the molecular sieve, but also improve the redox capacity. Molecular sieve-based catalysts with isolated Cu²⁺, a relatively high content of framework Fe³⁺, good redox performance and acidity have good catalytic activity for denitrification.

### Example 1

### 1. Method for Increasing the Loading Capacity of a Honeycomb Catalyst Support

The following raw materials were weighed in parts by mass: 45 parts of natural silica-aluminum mineral kaolin, 3 parts of sodium carboxymethyl cellulose, 5 parts of sesbania powder, 1 part of glass fiber with a length-diameter ratio of 2-4:1, 20 parts of water-soluble polyvinyl alcohol fiber bundles, 10 parts of wood chips, 7 parts of silica sol, 1 part of lactic acid, 1 part of nitric acid, 10 parts of glycerol, and 25 parts of deionized water.
(1) Natural silica-aluminum mineral kaolin, sodium carboxymethyl cellulose, sesbania powder, glass fiber, and wood chips were added into the mixer and the materials were then mixed thoroughly to obtain a homogeneous dry material.
(2) Water-soluble polyvinyl alcohol bundles were added and the materials were then mixed thoroughly.
(3) Then, silica sol, lactic acid, nitric acid, glycerol and deionized water were added for kneading.
(4) The mud kneaded in step (3) was repeatedly pugged twice or three times.
(5) The mud from step (4) was sealed with plastic wrap, and placed in a dry and cool place for aging for 48 h.
(6) The mud pugged in step (5) was fed into a forming machine for extrusion molding.
(7) The formed honeycombs were pre-dried to remove moisture by 5 wt % of the total mass, and then immersed into an alkali solution (NaOH solution) with a pH of 10 for 2 h. The honeycombs were taken out, and then placed into 60° C. water to remove the water-soluble polyvinyl alcohol fiber bundles. After being immersed for 10 h, the honeycombs were taken out and rinsed with 70° C. water for three times to obtain Material A.
(8) Material A was dried, and the drying curve was as follows: the material was dried at a temperature of 30° C., a humidity of 70% for 10 h; then, dried at a temperature of 50° C., a humidity of 60% for 5 h; and then dried at a temperature of 70° C., humidity of 30% for 3 h; and finally the material was transferred to a common oven to be dried at 100° C. for 3 h to obtain Material B.
(9) Material B was placed in a muffle furnace for calcination, and the calcining curve was as follows: calcination was initiated at 100° C., with the temperature increased at a rate of 0.5° C./min; when the temperature reached 200° C., the temperature was held for 2 h for binder removal; then, the material was further heated to 400° C. with a holding time of 2 h; and then the material was heated to 600° C. with a holding time of 8 h. Finally, a structured honeycomb catalyst support was obtained.

### 2. Preparation of a Denitrification Catalyst Based on the Catalyst Support Prepared Above

(1) 25 parts of FeCu-ZSM-5 molecular sieve, 2 parts of sodium carboxymethyl cellulose, 2 parts of lactic acid, 2 parts of silica sol, and 116 parts of deionized water, were mixed thoroughly to obtain a molecular sieve-based coating slurry.
(2) The structured honeycomb catalyst support was weighed and the mass was denoted as m₁, m₁32 61.31 g; the structured honeycomb catalyst support was completely immersed into the coating slurry for 4 h, and then taken out, and purged with compressed air (4 bar) until no liquid drops fell to ensure the honeycomb permeability, and then dried at 100° C. for 8 h to obtain Sample A.
(3) Sample A was completely immersed in the coating slurry for 4 h, taken out, and purged with compressed air (4 bar) until no liquid drops fell to ensure the honeycomb permeability, and then dried at 100° C. for 8 h to obtain Sample B.

Sample B was then weighed and the mass was denoted as m₂, m₂=71.58 g. The load rate was calculated according to the formula: L=(m₂−m₁)/m₁×100%, L=16.75%.
(4) Sample B was placed in a muffle furnace and heated to 600° C. and calcined for 5 h, with the temperature increased at a rate of 2° C./min, thus obtaining a high-load molecular sieve-based coated honeycomb monolithic denitrification catalyst.

The prepared high-load molecular sieve-based coated honeycomb monolithic denitrification catalyst was placed into a monolithic catalyst evaluation device, in which evaluation was conducted using simulated flue gas components including N₂, H₂O, NO, NH₃ and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst. The activity evaluation results are shown in FIGURE.

### Example 2

### 1. Method for Increasing the Loading Capacity of a Honeycomb Catalyst Support

The following raw materials were weighed in parts by mass: 37 parts of natural silica-aluminum mineral kaolin, 3 parts of sodium carboxymethyl cellulose, 5 parts of sesbania powder, 1 part of glass fiber with a length-diameter ratio of 2-4:1, 20 parts of water-soluble polyvinyl alcohol fiber bundles, 10 parts of wood chips, 7 parts of silica sol, 1 part of lactic acid, 1 part of nitric acid, 10 parts of glycerol, and 25 parts of deionized water.
(1) Natural silica-aluminum mineral kaolin, sodium carboxymethyl cellulose, sesbania powder, glass fiber, and wood chips were added into the mixer and the materials were then mixed thoroughly to obtain a homogeneous dry material.
(2) Water-soluble polyvinyl alcohol bundles were added and the materials were then mixed thoroughly.
(3) Then, silica sol, lactic acid, nitric acid, glycerol and deionized water were added for kneading.
(4) The mud kneaded in step (3) was repeatedly pugged twice or three times.
(5) The mud from step (4) was sealed with plastic wrap, and placed in a dry and cool place for aging for 48 h.
(6) The mud pugged in step (5) was fed into a forming machine for extrusion molding.
(7) The formed honeycombs were pre-dried to remove moisture by 5 wt % of the total mass, and then immersed into an alkali solution (NaOH solution) with a pH of 10 for 2 h. The honeycombs were taken out, and then placed into 60° C. water to remove the water-soluble polyvinyl alcohol fiber bundles. After being immersed for 10 h, the honeycombs were taken out and rinsed with 70° C. water for three times to obtain Material A.
(8) Material A was dried, and the drying curve was as follows: the material was dried at a temperature of 30° C., a humidity of 70% for 10 h; then, dried at a temperature of 50° C., a humidity of 60% for 5 h; and then dried at a temperature of 70° C., humidity of 30% for 3 h; and finally the material was transferred to a common oven to be dried at 100° C. for 3 h to obtain Material B.
(9) Material B was placed in a muffle furnace for calcination, and the calcining curve was as follows: calcination was initiated at 100° C., with the temperature increased at a rate of 0.5° C./min; when the temperature reached 200° C., the temperature was held for 2 h for binder removal; then, the material was further heated to 400° C. with a holding time of 2 h; and then the material was heated to 600° C. with a holding time of 8 h. Finally, a structured honeycomb catalyst support was obtained.
   2. Preparation of a denitrification catalyst based on the catalyst support prepared above
(1) 25 parts of FeCu-ZSM-5 molecular sieve, 2 parts of sodium carboxymethyl cellulose, 8 parts of aluminum sol, 2 parts of lactic acid and 116 parts of deionized water, were mixed thoroughly to obtain a molecular sieve-based coating slurry.
(2) The structured honeycomb catalyst support was weighed and the mass was denoted as m₁, m₁=67.46 g; the structured honeycomb catalyst support was completely immersed into the coating slurry for 4 h, and then taken out, and purged with compressed air (4 bar) until no liquid drops fell to ensure the honeycomb permeability, and then dried at 100° C. for 8 h to obtain Sample A.
(3) Sample A was completely immersed in the coating slurry for 4 h, taken out, and purged with compressed air (4 bar) until no liquid drops fell to ensure the honeycomb permeability, and then dried at 100° C. for 8 h to obtain Sample B.

Sample B was then weighed and the mass was denoted as m₂, m₂=82.81 g. The load rate was calculated according to the formula: L=(m₂−m₁)/m₁×100%, L=22.75%.
(4) Sample B was placed in a muffle furnace and heated to 600° C. and calcined for 5 h, with the temperature increased at a rate of 2° C/min, thus obtaining a high-load molecular sieve-based coated honeycomb monolithic denitrification catalyst.

The prepared high-load molecular sieve-based coated honeycomb monolithic denitrification catalyst was placed into a monolithic catalyst evaluation device, in which evaluation was conducted using simulated flue gas components including N₂, H₂O, NO, NH₃ and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst.

### Example 3

### 1. Method for Increasing the Loading Capacity of a Honeycomb Catalyst Support

The following raw materials were weighed in parts by mass: 34 parts of natural silica-aluminum mineral kaolin, 3 parts of sodium carboxymethyl cellulose, 5 parts of sesbania powder, 1 part of glass fiber with a length-diameter ratio of 2-4:1, 20 parts of water-soluble polyvinyl alcohol fiber bundles, 10 parts of wood chips, 7 parts of silica sol, 1 part of lactic acid, 1 part of nitric acid, 10 parts of glycerol, and 25 parts of deionized water.
(1) Natural silica-aluminum mineral kaolin, sodium carboxymethyl cellulose, sesbania powder, glass fiber, and wood chips were added into the mixer and the materials were then mixed thoroughly to obtain a homogeneous dry material.
(2) Water-soluble polyvinyl alcohol bundles were added and the materials were then mixed thoroughly.
(3) Then, silica sol, lactic acid, nitric acid, glycerol and deionized water were added for kneading.
(4) The mud kneaded in step (3) was repeatedly pugged twice or three times.
(5) The mud from step (4) was sealed with plastic wrap, and placed in a dry and cool place for aging for 48 h.
(6) The mud pugged in step (5) was fed into a forming machine for extrusion molding.
(7) The formed honeycombs were pre-dried to remove moisture by 5 wt % of the total mass, and then immersed into an alkali solution (NaOH solution) with a pH of 10 for 2 h. The honeycombs were taken out, and then placed into 60° C. water to remove the water-soluble polyvinyl alcohol fiber bundles. After being immersed for 10 h, the honeycombs were taken out and rinsed with 70° C. water for three times to obtain Material A.
(8) Material A was dried, and the drying curve was as follows: the material was dried at a temperature of 30° C., a humidity of 70% for 10 h; then, dried at a temperature of 50° C., a humidity of 60% for 5 h; and then dried at a temperature of 70° C., humidity of 30% for 3 h; and finally the material was transferred to a common oven to be dried at 100° C. for 3 h to obtain Material B.
(9) Material B was placed in a muffle furnace for calcination, and the calcining curve was as follows: calcination was initiated at 100° C., with the temperature increased at a rate of 0.5° C./min; when the temperature reached 200° C., the temperature was held for 2 h for binder removal; then, the material was further heated to 400° C. with a holding time of 2 h; and then the material was heated to 600° C. with a holding time of 8 h. Finally, a structured honeycomb catalyst support was obtained.

### 2. Preparation of a Denitrification Catalyst Based on the Catalyst Support Prepared Above

(1) 25 parts of FeCu-ZSM-5 molecular sieve, 2 parts of sodium carboxymethyl cellulose, 10 parts of aluminum sol, 2 parts of lactic acid and 116 parts of deionized water, were mixed thoroughly to obtain a molecular sieve-based coating slurry.
(2) The structured honeycomb catalyst support was weighed and the mass was denoted as m₁, m₁=61.31 g; the structured honeycomb catalyst support was completely immersed into the coating slurry for 4 h, and then taken out, and purged with compressed air (4 bar) until no liquid drops fell to ensure the honeycomb permeability, and then dried at 100° C. for 8 h to obtain Sample A.
(3) Sample A was completely immersed in the coating slurry for 4 h, taken out, and purged with compressed air (4 bar) until no liquid drops fell to ensure the honeycomb permeability, and then dried at 100° C. for 8 h to obtain Sample B.

Sample B was then weighed and the mass was denoted as m₂, m₂=80.31 g. The load rate was calculated according to the formula: L=(m₂−m₁)/m₁×100%, L=24.76%.
(4) Sample B was placed in a muffle furnace and heated to 600° C. and calcined for 5 h, with the temperature increased at a rate of 2° C./min, thus obtaining a high-load molecular sieve-based coated honeycomb monolithic denitrification catalyst.

The prepared high-load molecular sieve-based coated honeycomb monolithic denitrification catalyst was placed into a monolithic catalyst evaluation device, in which evaluation was conducted using simulated flue gas components including N₂, H₂O, NO, NH₃ and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst.

### Example 4

### 1. Method for Increasing the Loading Capacity of a Honeycomb Catalyst Support

The following raw materials were weighed in parts by mass: 50 parts of natural silica-aluminum mineral kaolin, 3 parts of sodium carboxymethyl cellulose, 5 parts of sesbania powder, 1 part of glass fiber with a length-diameter ratio of 2-4:1, 10 parts of wood chips, 7 parts of silica sol, 1 part of lactic acid, 1 part of nitric acid, 10 parts of glycerol, and 25 parts of deionized water.
(1) Natural silica-aluminum mineral kaolin, sodium carboxymethyl cellulose, sesbania powder, glass fiber, and wood chips were added into the mixer and the materials were then mixed thoroughly to obtain a homogeneous dry material.
(2) Then, silica sol, lactic acid, nitric acid, glycerol and deionized water were added for kneading.
(3) The kneaded mud was repeatedly pugged twice or three times.
(4) The mud from step (3) was sealed with plastic wrap, and placed in a dry and cool place for aging for 48 h.
(5) The mud pugged in step (4) was fed into a forming machine for extrusion molding.
(6) The formed honeycombs were pre-dried to remove moisture by 5 wt % of the total mass, and then immersed into an alkali solution (NaOH solution) with a pH of 10 for 2 h. The honeycombs were taken out, and then placed into 60° C. water to remove the water-soluble polyvinyl alcohol fiber bundles. After being immersed for 10 h, the honeycombs were taken out and rinsed with 70° C. water for three times to obtain Material A.
(7) Material A was dried, and the drying curve was as follows: the material was dried at a temperature of 30° C., a humidity of 70% for 10 h; then, dried at a temperature of 50° C., a humidity of 60% for 5 h; and then dried at a temperature of 70° C., humidity of 30% for 3 h; and finally the material was transferred to a common oven to be dried at 100° C. for 3 h to obtain Material B.
(8) Material B was placed in a muffle furnace for calcination, and the calcining curve was as follows: calcination was initiated at 100° C., with the temperature increased at a rate of 0.5° C./min; when the temperature reached 200° C., the temperature was held for 2 h for binder removal; then, the material was further heated to 400° C. with a holding time of 2 h; and then the material was heated to 600° C. with a holding time of 8 h. Finally, a structured honeycomb catalyst support was obtained.

### 2. Preparation of a Denitrification Catalyst Based on the Catalyst Support Prepared Above

(1) 25 parts of FeCu-ZSM-5 molecular sieve, 2 parts of sodium carboxymethyl cellulose, 10 parts of silica sol, 2 parts of lactic acid and 116 parts of deionized water, were mixed thoroughly to obtain a molecular sieve-based coating slurry.

(2) The structured honeycomb catalyst support was weighed and the mass was denoted as m₁, m₁=62.31 g; the structured honeycomb catalyst support was completely immersed into the coating slurry for 4 h, and then taken out, and purged with compressed air (4 bar) until no liquid drops fell to ensure the honeycomb permeability, and then dried at 100° C. for 8 h to obtain Sample A.
(3) Sample A was completely immersed in the coating slurry for 4 h, taken out, and purged with compressed air (4 bar) until no liquid drops fell to ensure the honeycomb permeability, and then dried at 100° C. for 8 h to obtain Sample B.

Sample B was then weighed and the mass was denoted as m₂, m₂=68.56 g. The load rate was calculated according to the formula: L=(m₂−m₁)/m₁×100%, L=10.03%.
(4) Sample B was placed in a muffle furnace and heated to 600° C. and calcined for 5 h, with the temperature increased at a rate of 2° C./min, thus obtaining a high-load molecular sieve-based coated honeycomb monolithic denitrification catalyst.

The prepared high-load molecular sieve-based coated honeycomb monolithic denitrification catalyst was placed into a monolithic catalyst evaluation device, in which evaluation was conducted using simulated flue gas components including N₂, H₂O, NO, NH₃ and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst. The activity evaluation results are shown in FIGURE.

The results of activity comparison between Example 1 (having a structuring agent added) and Example 4 (no structuring agent added) are shown in FIGURE. It can be seen from FIGURE that after adding a structuring agent, the overall activity of the catalyst is significantly improved.

What is claimed is:

1. A method for increasing a loading capacity of a clay-based honeycomb catalyst support, the method comprising the following steps:
(1) mixing a structuring agent and additives with a main material which is a natural silica-aluminum mineral to obtain a homogeneous powder; adding wet materials, and performing kneading, mud pugging, aging, extrusion molding, and pre-drying to obtain a clay-based honeycomb monolithic denitrification catalyst support,
wherein the structuring agent is a water-soluble polymer fiber bundle,
the additives comprise an organic binder, an extrusion aid, a pore-forming agent and a structure enhancer, and the wet materials comprise an inorganic binder, an organic acid, an inorganic acid, a humectant and water;
(2) immersing the clay-based honeycomb monolithic denitrification catalyst support in an alkali solution for etching treatment: the alkali solution has a pH of 8 to 13 and a temperature of 20° C. to 90° C., and the immersion time ranges from 2 h to 4 h;
(3) then, performing structuring water dissolution treatment on the clay-based honeycomb monolithic denitrification catalyst support: immersing the clay-based honeycomb monolithic denitrification catalyst support in water with a temperature of 20° C. to 90° C. for 0.5 h to 2.0 h, and then rinsing with water with a temperature of 20° C. to 90° C. twice or three times; and
(4) drying and calcining the clay-based honeycomb monolithic denitrification catalyst support to obtain the structured clay-based honeycomb catalyst support.

2. The method for increasing a loading capacity of a clay-based honeycomb catalyst support according to claim 1, wherein the water-soluble polymer fiber bundle is one of polyvinyl alcohol fiber, seaweed fiber, and carboxymethyl cellulose fiber or a combination thereof.

3. The method for increasing a loading capacity of a clay-based honeycomb catalyst support according to claim 1, wherein the organic binder is one of sodium carboxymethyl cellulose, sodium hydroxypropyl cellulose, polyethylene glycol, sodium polyacrylate, polyethylene oxide, and phenolic resin or a combination thereof; the extrusion aid is one of starch, sesbania powder, ethanolamine and sodium stearate or a combination thereof; the pore-forming agent is one of straw, rice hull, sawdust, wood chips and bamboo chips or a combination thereof; the structure reinforcer is glass fiber; the inorganic binder is one of silica sol, water glass, pseudo-boehmite and aluminum sol or a combination thereof; the organic acid is one of citric acid, tartaric acid, malic acid, oxalic acid and lactic acid or a combination thereof; and the inorganic acid is one of hydrochloric acid, nitric acid, sulfuric acid, phosphoric acid, carbonic acid and boric acid or a combination thereof; the humectant is one of glycerol, tung oil and peanut oil or a combination thereof.

4. The method for increasing a loading capacity of a clay-based honeycomb catalyst support according to claim 1, wherein a mass ratio of the raw materials added is as follows: the natural silica-aluminum mineral:the organic binder:the extrusion aid:the structure enhancer:the structuring agent:the pore-forming agent:the inorganic binder:the organic acid:the inorganic acid:the humectant:the water=45-100:1-5:1-8:1-5:10-50:1-15:3-8:1-5:1-5:3-10:10-30.

5. The method for increasing a loading capacity of a clay-based honeycomb catalyst support according to claim 1, wherein in the step (4), the drying is performed according to a temperature-humidity coordinated cross-control method, and temperature ranges from 25° C. to 100° C. and humidity ranges from 5% to 80%;
the calcination is performed in a way of initiating calcination from a temperature of greater than 80° C. with temperature increased at a low rate of 0.5° C./min to 2° C./min, and when the temperature reaches a temperature ranging from 180° C. to 400° C., holding the temperature for 2 h for binder removal, and then further heating to a temperature ranging from 550° C. to 800° C. with a holding time of 6 h to 8 h for calcination.

6. A clay-based honeycomb catalyst support obtained by the method according to claim 1.

7. A method for preparing a high-load molecular sieve-based coated honeycomb monolithic denitrification catalyst based on the clay-based honeycomb catalyst support according to claim 6, the method comprising the following steps:
a) thoroughly mixing a molecular sieve, an organic binder, an inorganic binder, an acid and water in a mass ratio of 10-30:0-10:0-10:3-10:50-90 to obtain a molecular sieve-based coating slurry;
b) completely immersing the clay-based honeycomb catalyst support into the molecular sieve-based coating slurry for 4 h to 8 h, and then taking the clay-based honeycomb catalyst support out; then, immersing the clay-based honeycomb catalyst support again in the molecular sieve-based coating slurry for 4 h to 8 h, and then taking out to obtain a primary product; and
c) calcining the primary product at a temperature of 500° C. to 600° C. to obtain the high-load molecular sieve-based coated honeycomb monolithic denitrification catalyst.

8. The method for preparing a high-load molecular sieve-based coated honeycomb monolithic denitrification catalyst according to claim 7, wherein in the step a), the molecular sieve is one of ZSM-5 molecular sieve, ZSM-35 molecular sieve, SSZ-13 molecular sieve, SSZ-39 molecular sieve, SAPO-11 molecular sieve, SAPO-34 molecular sieve, SAPO-47 molecular sieve, Y-type molecular sieve, Beta molecular sieve, KFI type molecular sieve and mordenite or a combination thereof, and a molar ratio of silica to alumina in the molecular sieve is 2-300:1; a metal element contained in the molecular sieve is one of iron, copper, manganese, cerium, lanthanum, rhodium, ruthenium, palladium and osmium or a combination thereof, and a content of the metal element ranges from 0.1 wt % to 10.0 wt %.

9. The method for preparing a high-load molecular sieve-based coated honeycomb monolithic denitrification catalyst according to claim 7, wherein in the step a), the organic binder is one of sodium carboxymethyl cellulose, polyethylene glycol, polyethylene oxide, sodium polyacrylate and polyimide resin or a combination thereof; the inorganic binder is silica sol or aluminum sol; the acid is one of lactic acid, nitric acid, hydrochloric acid, sulfuric acid, phosphoric acid, carbonic acid and boric acid or a combination thereof.
